(19) United States
(12) Patent Application Publication
(10) Pub. No.: US 2006/0288845 A1
(43) Pub. Date: Dec. 28, 2006

(54) Preference-weighted semi-random media play

(76) Inventor: Joshua Gale, New York, NY (US)

Correspondence Address: ANDREW MCALEAVEY, 4600 ADELINE ST., #101, EMERYVILLE, CA, 94608, US

(21) Appl. No.: 11/166,282

(22) Filed: Jun. 24, 2005

(51) Int. Cl. G10H 7/00; A63H 5/00; G04B 13/00

(52) U.S. Cl. 84/609

(57) ABSTRACT

Methods, apparatus, and systems that allow random music play, and random selection of other media files, using a non-uniform probability distribution. The likelihood that a particular song, piece, or media file will be played or presented in the future is increased or decreased according to positive and negative user behaviors noted with respect to previous plays of the same media file, such as how long the user listens to or views a song, piece, or file; whether the user manually selects a song, piece, or file for play or presentation; and whether the user “skips” a song while it is being played, or otherwise actively chooses not to listen to a song.

### BACKGROUND OF THE INVENTION

1. Field of the Invention

The invention generally relates to media file play and, more particularly, to methods, apparatus, and systems that determine the order and frequency with which particular media files are played.

2. Description of Related Art

For many years, the musical album has been the dominant mechanism by which music is distributed to the public. In a musical album, the type, number, and order of songs or musical pieces are predetermined. Oftentimes, the musical artist or album producer includes particular songs in a particular order on the album to create an overall artistic effect.

However, users sometimes wish to hear songs or pieces out of their designated order. Therefore, many musical players include a random selection function that uses a simple random number generator to pick a song or piece at random from among all of the available songs or musical pieces. In mathematical terms, the typical random selection function has a uniform probability distribution, i.e., it is equally likely that any available song will be chosen for play at any time.

In addition to random play, many users have invested hours in producing their own mix cassettes or CDs that contain music in a user-selected (but also pre-determined) order. Making a mix cassette or CD often requires the user to copy selected songs manually, which can be very time-consuming.

Recently, musical distribution has shifted away from albums and toward systems in which musical songs or pieces are distributed to the public individually, typically using electronic systems and/or the Internet. This mode of distribution caters to the individual desires of music consumers and users, who no longer need to purchase an entire album to enjoy a single song.

As individual distribution of songs and musical pieces has become popular, the old desires for user-determined order and frequency of song play have resurfaced. On many modern digital music players, users can create playlists that dictate the order and frequency with which particular songs or pieces are played. Some musical players and systems also allow a user to manually “rate” a song (e.g., with one to five stars, or based on specific criteria) and will play highly rated songs more frequently. Some players can also order songs or musical pieces for play depending on the frequency with which they have been played in the past. Because many modern music players can hold many thousands of songs at once, playlists can be very useful in ensuring that a user is able to listen to favorite music or to music that fits a particular mood or situation.

However, useful as they may be, playlists can be cumbersome to manage and can take hours to construct. Systems that select songs randomly for play based on user ratings typically require a user to inventory his or her collection and assign the ratings manually, which may be just as time-consuming as arranging a playlist. (Moreover, if a song or piece later becomes less favored, the user must then manually change the rating.) Additionally, although frequency-based song selection systems can ensure that favorite songs are played without undue effort on the part of the user, these systems may overplay a very limited selection of songs or musical pieces, which may bore or irritate the user.

### SUMMARY OF THE INVENTION

One aspect of the invention relates to a method of selecting and ordering media for play on a media player. The method comprises selecting a media file for play from a group of media files at random using a non-uniform probability distribution in which the probability that the media file will be played is influenced by one or more positive or negative user behaviors noted with respect to prior plays of the media file.

Another aspect of the invention relates to a media player. The media player comprises a media rendering device, a storage medium, selection controls, and a processor. The processor is coupled to the media rendering device, the storage medium, and the user selection controls. It is adapted to select a media file for play from a group of media files at random using a non-uniform probability distribution in which the probability that the media file will be played is influenced by one or more positive or negative user behaviors noted with respect to prior plays of the media file.

A further aspect of the invention relates to a music player. The music player comprises a storage medium having a group of songs stored thereon, an audio output device, and a processor coupled to the storage medium and the output device. The processor selects a song for play at random from among the group of songs using a non-uniform probability distribution that changes based on which ones of the group of songs the user listens to and which ones of the group of songs the user skips.

Other aspects, features, and advantages will become clear from the description that follows.

### BRIEF DESCRIPTION OF THE DRAWINGS

Embodiments of the invention will be described with reference to the following drawing figures, in which like numbers refer to like elements throughout the figures, and in which:

FIG. 1 is a schematic diagram of a media rendering system according to an embodiment of the present invention;

FIG. 2 is a high-level flow diagram of a semi-random media selection algorithm according to an embodiment of the present invention that may be implemented on the media rendering system of FIG. 1;

FIGS. 3-5 are graphs schematically depicting the probabilities of play for various media after various iterations of the method of FIG. 2;

FIGS. 6-8 are schematic diagrams of data structures illustrating one way of representing probability of play data through various iterations of the method of FIG. 2; and

FIGS. 9-11 are schematic diagrams of alternative data structures illustrating another way of representing probability of play data through various iterations of the method of FIG. 2.

### DETAILED DESCRIPTION

Embodiments of the invention provide methods, apparatus, and systems that allow random music play, and random selection of other media files, using a non-uniform probability distribution. The likelihood that a particular song, piece, or media file will be played or presented in the future is increased or decreased according to positive and negative user behaviors noted with respect to previous plays of the same media file, such as how long the user listens to or views a song, piece, or file; whether the user manually selects a song, piece, or file for play or presentation; and whether the user “skips” a song while it is being played, or otherwise actively chooses not to listen to a song.

Throughout the description that follows, the terms “music” and “song” should be construed to refer to musical pieces and songs, whether formally published or not, as well as media of various types to which a user might desire to apply the methods described here. For example, other types of media may include audio books, video clips, music videos, recorded spoken media, and photographs or pictures. If the term “piece” or “song” is used alone, unless otherwise stated, it should be understood that the term refers equally to songs, musical pieces, and other media. Additionally, although it may be more correct to describe the selection methodologies described herein as random selection using a non-uniform probability distribution, the term “semi-random” will be used in some instances for ease and clarity in description.

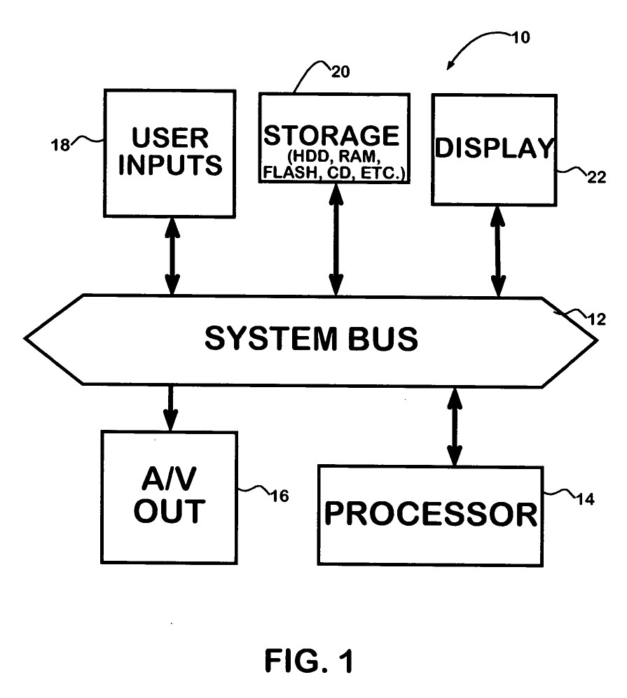

FIG. 1 is a schematic diagram of a media file rendering system, generally indicated at 10. Depending on the particular implementation, media file rendering system 10 may be a personal computer, a digital music player (such as the iPOD™ line of personal music players manufactured by Apple Computer of Cupertino, Calif.), a video player, or a CD player.

Media file rendering system 10 has a system bus 12 to which a number of other components may be connected. (The term “bus” may refer specifically to the internal communication mechanisms used by personal computers and other devices, as well as more generally to any internal communication mechanism that allows different devices in or portions of media file rendering system 10 to communicate.) Connected to system bus 12 is a processor 14. Processor 14 is responsible for the computations necessary to convert a media file from digital stored format to the appropriate audio or visual format, and is also responsible for the computations and other processing needed to read user selections and otherwise interact with the user. Depending on the implementation, processor 14 may be a microprocessor, an application specific integrated circuit (ASIC), a number of independent elements that cooperate to perform the described functions, or any other circuit, arrangement of circuits, or device capable of performing the described functions.

Also connected to system bus 12 is an A/V out 16, user inputs 18, a storage medium 20, and a display 22. User inputs 18 may comprise a conventional keyboard, a number of buttons, or a number of more specialized controls that allow the user to select a particular media file from among a group of media files stored in storage device 20 using display 22 as necessary. Once selected, the media file is output to either AN out 16 (for example, in the case of a music file), display 22, or display 22 and AN out 16. Storage device 20, which is shown schematically in FIG. 1, may be a hard disk drive, random access memory (RAM), flash or nonvolatile memory, a compact disk reader, a DVD reader, or any other device or set of devices capable of storing media files. Storage device 20 may actually comprise a number of storage devices of the same or different types. Typically, for example, if the primary storage device is a hard disk drive, media file rendering system 10 will also include RAM.

As an example, a user may select a song from among a number of songs stored on media file rendering system 10 using user inputs 18. His or her selection is then retrieved from storage device 20 and played to the AN out 16, which, in this example, may be assumed to be a headphone jack. During the selection process, display 22 serves to display to the user his or her options for songs to be played. In other embodiments of media file rendering system 10, display 22 may be absent (or, alternatively, may be as simple as one or more LED indicators).

In the example of the previous paragraph, the user selects each of the songs to be played. However, media file rendering system 10 is also capable of semi-random selection of media files from among the group of media files on storage device 20 based on positive and negative user behaviors.

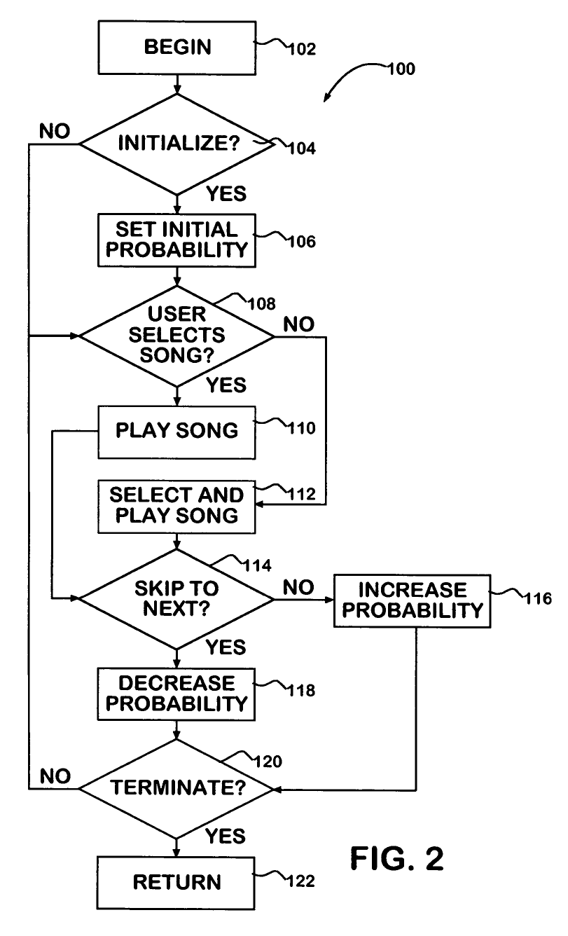

FIG. 2 illustrates a method, generally indicated at 100, of semi-random selection of media files based on positive and negative user behaviors. Method 100 may be implemented on media file rendering system 10 or any other system capable of performing the tasks. (For the purpose of the following description, it will be assumed that the media files are songs.) Method 100 begins at task 102 and control passes to task 104. At task 104, it is determined whether initialization is necessary, that is, whether method 100 has been performed before.

In order to make this determination, for example, processor 14 might check storage device 22 to see whether probability of play data exists for each song on storage device 22 (or, alternatively, each song in a particular listing, directory, or playlist designated by the user). Probability data would typically be stored in one or more files that can be loaded into appropriate data structures for manipulation by processor 14. If probability data does not exist on storage device 22 initialization would be deemed necessary (task 104:YES) and control of method 100 would continue with task 106, in which an initial probability of play is set for each song on storage device 20.

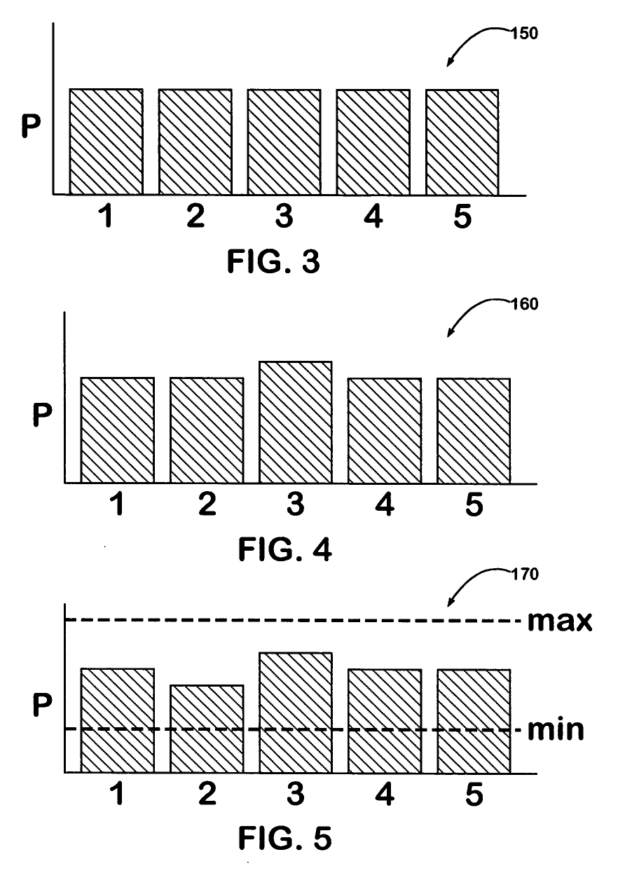

The initialization task may be better understood with reference to FIG. 3, a graph 150 illustrating an initial probability distribution for a number of songs. In graph 150, there are five songs, numbered 1 to 5 along the X-axis of the graph. Along the Y-axis is the probability that each one of the songs will be played. Initially, as can be seen in graph 150, the probability that each of the songs will be played is set to the same nonzero probability for each of the files. (In other embodiments, the initial probabilities need not be set the same for each song and could, for example, be set initially based on genre or other factors.)

With respect to method 100, after initialization in task 106, or after it is determined that no initialization is required (task 104:NO), control passes to task 108, in which it is determined whether a user has selected a song or a for play. If the user has selected a song or for play (task 108:YES), control passes to task 110 and the song is played. If the user does not affirmatively select a song for play in task 108 (task 108:NO), control passes to task 112 and a song is selected semi-randomly for the user using the existing probability set and played. Tasks 108-112 may be implemented by prompting the user to select a song and allowing some reasonable period of time to elapse before one is selected semi-randomly and played, or by using an event- or interrupt-driven scheme in which a song is selected semi-randomly and played unless the user manually selects a song.

After task 112, method 100 continues at task 114 by determining whether a user has directed media file rendering system 10 to skip to the next song before the selected song has been played. Skipping to the next song is a negative user behavior, an indication that a user does not prefer a particular song. Therefore, if the user does skip to the next song (task 114:YES), method 100 continues at task 118 by decreasing the probability that that particular song will be played in the future.

If the user does not skip the song when method 100 reaches task 114 (task 114:NO), control passes to task 116. Listening to an entire song, or to a substantial portion of a song, it is a positive user behavior that indicates that the user has a preference for the particular song. Therefore, in task 116, the probability of that song being played is increased. Note that in methods according to embodiments of the invention, the user need not listen to an entire song in order to have its probability of play increased; a threshold, such as listening to 50% of a song, could be set for increasing that song's probability of play.

Setting a play threshold for increasing a song's probability of play can overcome the issue of song fade out. Most songs fade out toward the end (i.e., the volume of the song gradually decreases), and the fade may last several seconds. However, a user may not wish to listen to the entire fade out, choosing instead to skip to the next song. If no threshold is set, the probability of play might not be increased although the user, for all practical purposes, did listen to the song. However, if a play threshold (e.g., in this case, play of 90% of the song) is set, the song's probability of play can be increased despite the fact that the terminal, fading portion of it is skipped. (By contrast, and merely for the sake of illustration, versions of the iTunes™ music player software (Apple Computer, Inc., Cupertino, Calif.) available at the time of writing do not register that a song has been played and increment the play count for that song unless the entire song has been played, and, conversely, increment the play count if the song finishes even if the user fast-forwarded through most of the song to reach the end. Both of these behaviors hinder the ability to create a true “most played songs” list.)

After both tasks 116 and 118, control of method 100 passes to task 120, in which it is decided whether or not method 100 should be terminated. (As with other decision tasks described here, this may be implemented by prompting the user and allowing some appropriate time period to elapse, or by implementing an event- or interrupt-based scheme in which method 100 would continue unless it was affirmatively terminated.) If method 100 is not to be terminated (task 120:NO), control returns to task 108. If method 100 is to be terminated (task 120:YES), it terminates and returns to other programming at task 122.

It should be understood that the tasks described above, particularly tasks 108-112, could apply to songs as well as playlists of songs. For example, if the user does not select a particular song (task 108:NO), he or she could alternatively select a playlist, in which case, semi-random play would proceed using the songs in that particular playlist, unless the user affirmatively selects a song for play from among the songs in the playlist.

The concepts of increasing and decreasing the probability of play of a particular song relative to the others that are described with respect to tasks 116 and 118 may be better understood with reference to FIGS. 4 and 5, which depict graphs 160 and 170 that are similar to graph 150 of FIG. 3. Specifically, in graph 160, it is assumed that the user listened to the entirety of song #3, or, alternatively, to some threshold portion (e.g. 50%) of song #3. Accordingly, graph 160 shows that the probability of playing song #3 has been increased so that it is slightly greater than the probability of playing the other songs. Thus, the probability distribution is no longer uniform, and if no additional changes are made, it can be expected that song #3 will be played with slightly more frequency than the other songs in the future.

Graph 170 illustrates the probability set of graph 160 after task 118. Specifically, in graph 170, it is assumed for the sake of example that the user was listening to song #2 and skipped to the next song without listening to the entire song or a threshold portion of it. Consequently, the probability that song #2 will be played in the future is decreased. Note that even though the probability that song #2 will be played is decreased, it is nonzero, i.e., song #2 will still be played, but with less frequency. Note also that the probability of playing song #3 is still elevated.

Graph 170 also illustrates another feature of this embodiment of the invention: maximum and minimum probability thresholds, which are indicated by dotted lines labeled “max” and “min” in FIG. 5. As will be appreciated, if the user were to repeatedly manually select a song or repeatedly skip a song, a situation would arise in which the play of a particular song was virtually certain, or in which the probability of play of another song was zero or near zero. Therefore, in some embodiments, checks may be made to see that the probabilities do not rise above or fall below certain thresholds. This may be implemented by checking to see whether certain pre-set thresholds have been met or exceeded before increasing or decreasing the probability of playing a particular song. (These checks are not illustrated in the more general diagram of FIG. 2.)

Of course, FIG. 2 illustrates a basic method according to one embodiment of the invention. In particular, method 100 illustrates only one type of positive user behavior and one type of negative user behavior. Other positive and negative user behaviors may be included in these methods. For example, if a user affirmatively selects a song for play in task 108 of method 100, this could be considered a positive user behavior and the probability of play for that song could be increased as a result of it. Additionally, skipping, fast forwarding, and “rewinding” within a song could all be considered actionable user behaviors, albeit user behaviors that may be considered to be either positive or negative, depending on the circumstances. If more than one positive and more than one negative user behavior are recognized and acted upon in a method, it may be desirable to implement a threshold whereby the probability of play for a particular song could not be increased or decreased too much in any one iteration of the method.

For example, assume that affirmative selection of a song and listening to an entire song are both recognized positive user behaviors. Assume further that a user affirmatively selects a particular song for play and then listens to the entirety of it (which is not an uncommon situation, assuming that the user wishes to listen to what he or she selects). Checks could be implemented to see that its probability of play was only increased by one increment, rather than two, despite the fact that that particular song had been subject to two positive user behaviors in one iteration of the method. This could be done by instituting a decision step just prior to, for example, task 116 of method 100, that checks to see whether the probability of play for that song has already been increased during the present iteration of the method.

There are a number of ways of representing the probability data for each media file so that methods such as method 100 can be implemented on systems such as media file rendering system 10. Most systems on which method 100 might be implemented have a random number generating function that generates a random number using a uniform probability distribution (i.e., with an equal likelihood that all numbers will be selected). Since this capability is common, it may be advantageous to use it in embodiments of the invention.

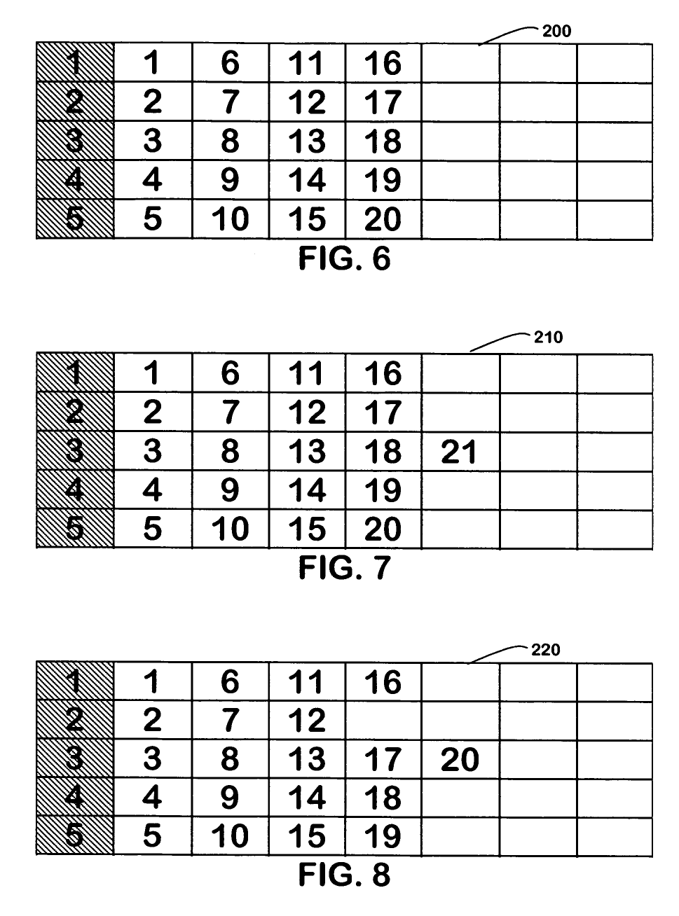

FIGS. 6-8 are schematic representations of data structures illustrating one way of implementing method 100 using a common random number generator. Data structure 200 illustrates the arrangement after initialization. In data structure 200, it is assumed that there are five songs, although an arbitrary large number of songs may be included in the probability distribution. It is also assumed that data structure 200 is initialized with the probability of playing each song being the same, although this need not necessarily be the case. In data structure 200, the five songs, numbered 1 to 5, are arranged in the leftmost column. Following each song number is a row with seven columns. In this example, the system on which the method is performed will initially be asked to select a number from 1 to 20, and that selected random number will be mapped to a particular song number using data structure 200 to determine which song should be played. Therefore, the columns following the five song numbers are populated with the numbers 1 through 20, with four numbers assigned to each song. For example, as shown, the numbers 1, 6, 11, and 16 are assigned to song #1, and song #1 will thus be played if any one of those numbers is generated by the random number generator. The particular manner in which the numbers are assigned is not critical; however, if the probability distribution is to be uniform after initialization, then the same number of numbers should be assigned to each song.

Using the probability distribution represented by data structure 200, a random number between 1 and 20 is generated and each song has four chances of being selected out of a total of 20 possible outcomes. However, note the three empty columns for each song number. FIG. 7 and data structure 210 represent the situation after one song, song #3, has been increased in probability. The number 21 is added to one of the empty columns for song #3, and the system will be asked to generate a random number from 1 to 21 in the future. Song #3 has five chances of being selected out of those 21 possible outcomes (i.e., it will be played if the random number generated by the system is 3, 8, 13, 18, or 21), giving it a slightly elevated probability of being selected over the other songs, which have only four chances out of 21. (From a technical standpoint, the probabilities of playing the other songs are also slightly decreased, as these songs have only a 4/21 chance of being played, rather than a 4/20 chance.)

FIG. 8 and data structure 220 represent the cumulative situation after another song, song #2, has been decreased in probability. Song #2 is given one less number, and the numbers in the data structure are renumbered to eliminate the number that had previously been assigned to song #2. Thus, in this example relative to data structure 210, the number 17 has been removed from song #2 and numbers higher than 16 have been renumbered. The system on which the method is implemented will be asked to select a random number between 1 and 20 in the future. Song #2 will have a probability of 3/20 of being played (i.e., it will be played if the numbers 2, 7, or 12 are selected).

Note that data structures 200, 210, and 220 are conducive to implementing maximum and minimum probability thresholds. As shown, none of these data structures 200, 210, 220 can accommodate more than 7 chances for an individual song, and the implementing method can be adapted to ensure that at least one chance remains for each song. Data structures 200, 210, and 220 may be implemented as arrays, linked lists, or any other data structure or database format capable of representing the data.

As was described above, any number of songs may be included in data structures 200, 210, and 220. Mathematical simulations of data structures 200, 210, and 220 programmed using Microsoft Visual Basic Script and implemented using Microsoft Excel (Microsoft Corporation, Redmond, Wash.) with 150 simulated songs using random numbers selected from 1 to 600 have proven successful. The ultimate number of songs that may be included depends on the capabilities of the implementing system.

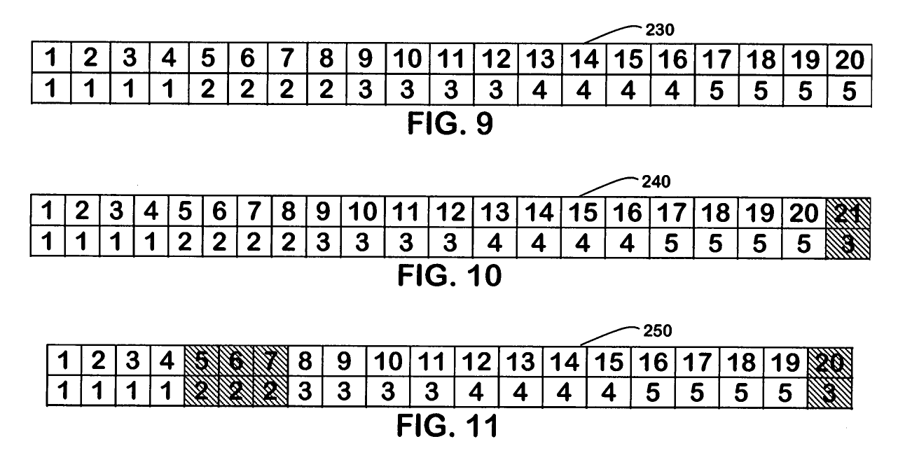

With data structures 200, 210, and 220, the indexing is by song number. It is also possible to index by random number. For example, FIGS. 9-11 illustrate data structures 230, 240 and 250, which are indexed by random number. For example, with respect to data structure 230, it is assumed that there are 20 possible outcomes, and the numbers 1 to 20 are each associated with a song number, in this case 1 to 5 (assuming, once again, that there are five songs). In data structure 240, the probability of playing song #3 is increased, and so the number 21 is added to the structure, associated with song #3. In data structure 250, the probability of playing song #2 is decreased, and so one of its numbers is deleted. It will be understood that data structures 230, 240, and 250 merely illustrate another way to represent the data; the method described above remains unchanged.

Depending on the particular implementation, it may be advantageous to store other information along with the probability distributions. For example, if there is a need to determine whether the probability of play for any particular song has been incremented more than once during a particular iteration of the method, the data structures could include a flag for each song that is set when its probability is incremented up or down and reset before the next iteration. The number of times a song has been played in the recent past could also be stored.

Those of skill in the art will realize that there are other ways of creating, representing, and calculating with non-uniform probability distributions. For example, the familiar normal (“bell curve” or Gaussian) probability distribution, in its continuous form, is described by the equation:

$$PDF = \frac{1}{B \sqrt{2 π}} exp ( - \frac{1}{2} {( \frac{y - A}{B} )}^{2} )$$

In the above equation, there are two parameters. As is well known, the parameter A describes the location of the mean, and the parameter B describes the standard deviation. In other embodiments, the probabilities of playing the songs could be represented by a probability distribution function such as the normal distribution, and the parameters descriptive of the probability distribution function could be changed in response to positive and negative user behaviors. For example, in the case of the normal distribution, the mean could coincide with the most popular song, and the location of the mean could shift as the most popular song changes.

Any one of a number of probability distribution functions may be used to represent the relative probabilities of play, and the type of probability distribution used would depend on the state of the probability data. The appropriate settings and parameter values for probability distribution functions may be derived, for example, by determining how much the probability shifts in the examples given above (e.g., from a probability of 4/20 to a probability of 5/21 with one increment) and choosing the parameters of the distribution functions to approximate about that much of a change in the probability of play with each increment. In general, this approach would skew the probability of play toward a particular song.

Thus, the methods, apparatus, and systems described here provide for semi-random selection of songs and other media files based on positive and negative user behaviors. However, as has been illustrated, the essentially random nature of selection has been preserved. An advantage of these methods, apparatus, and systems is that a user does not need to take any special action to configure the semi-random play; his or her normal actions in the course of play will automatically cause preferred songs to be played with more frequency, and will automatically cause those songs to be played with less frequency if the user behaves in a way that indicates he or she no longer prefers those songs. An additional advantage of these methods, apparatus, and systems is that because no special action is required on the part of the user, the implementation may be entirely transparent to the user.

The methods, systems, and apparatus described here may also be used any with other play management functions common in music and other types of media players. For example, if the player or system allows the user to manually rate songs or other media files to indicate which are preferred (as in the iTunes™ software), the methods, systems, and apparatus described here would leave those ratings undisturbed, and the user would be free to continue to use them.

While the invention has been described with respect to certain exemplary embodiments, it will be realized that the description presented here is not intended to be limiting. Modifications and changes may be made within the scope of the invention.

What is claimed is:

1. A method of selecting and ordering media for play on a media player, comprising:
selecting a media file for play from a group of media files at random using a non-uniform probability distribution in which the probability that the media file will be played is influenced by one or more positive or negative user behaviors noted with respect to prior plays of the media file.

2. The method of claim 1, further comprising:
increasing the probability that the media file will be played in the future if one or more of the positive user behaviors is noted in association with play of the media file, unless the probability that the media file will be played is equal to or greater than a maximum probability threshold; and
decreasing the probability that the media file will be played in the future if one or more of the negative user behaviors is noted in association with play of the media file, unless the likelihood that the media file will be played is equal to or less than a minimum probability threshold.

3. The method of claim 2, wherein the positive user behaviors comprise one or more behaviors selected from the group consisting of specific selection of the media file for play, allowing play of the media file to be completed, and allowing a threshold portion of a media file to be played.

4. The method of claim 2, wherein the negative user behaviors comprise causing the media player to skip to a next media file without completing play of the media file.

5. The method of claim 2, further comprising, for each one of the group of media files, setting the probability that the particular one of the group of media files will be played to an initial value.

6. The method of claim 5, wherein the initial value is the same for each of the group of media files.

7. The method of claim 1, wherein the media file is of a type selected from the group consisting of a sound recording, a image, and an animated series of images.

8. Machine-readable instructions interoperable with a machine to perform the tasks of claim 1.

9. Machine-readable instructions interoperable with a machine to perform the tasks of claim 2.

10. A media player, comprising:
a media output device;
a storage medium;
selection controls; and
a processor coupled to the media rendering device, the storage medium, and the user selection controls, the processor being adapted to select a media file for play from a group of media files stored on the storage medium at random using a non-uniform probability distribution in which the probability that the media file will be played is influenced by one or more positive or negative user behaviors noted with respect to prior plays of the media file.

11. The media player of claim 10, wherein:
the processor increases the probability that the media file will be played in the future if one or more of the positive user behaviors is noted in association with play of the media file, unless the probability that the media file will be played is equal to or greater than a maximum probability threshold; and
the processor decreases the probability that the media file will be played if one or more of the negative user behaviors is noted in association with play of the media file, unless the probability that the at least one media file will be played is equal to or less than a minimum probability threshold.

12. The media player of claim 11, wherein the probability that the media file will be played is stored on the storage medium.

13. The media player of claim 12, wherein the maximum probability threshold and the minimum probability threshold are stored on the storage medium.

14. The media player of claim 11, wherein the positive user behaviors comprise one or more behaviors selected from the group consisting of using the selection controls to select the media file for play, allowing play of the media file to be completed, and allowing a threshold portion of a media file to be played.

15. The media player of claim 10, wherein the media output device comprises an audio output device coupled to the processor.

16. The media player of claim 10, wherein the media output device comprises a video output device coupled to the processor.

17. The media player of claim 10, wherein the storage medium comprises a hard disk.

18. The media player of claim 10, wherein the storage medium comprises non-volatile memory.

19. The media player of claim 10, wherein the storage medium comprises a compact disk.

20. A music player, comprising:
a storage medium having a group of songs stored thereon;
an audio output device; and
a processor coupled to the storage medium and the audio output device that selects a song for play at random from among the group of songs using a non-uniform probability distribution that changes based on which ones of the group of songs the user listens to and which ones of the group of songs the user skips.
